(19) United States
(12) Patent Application Publication
(10) Pub. No.: US 2018/0253811 A1
(43) Pub. Date: Sep. 6, 2018

(54) CAREER GAP IDENTIFIER

(71) Applicant: Mom Chan, Sherman Oaks, CA (US)

(72) Inventor: Mom Chan, Sherman Oaks, CA (US)

(21) Appl. No.: 15/450,046

(22) Filed: Mar. 6, 2017

(51) Int. Cl. G06Q 50/20; G06Q 10/10

(52) U.S. Cl. CPC G06Q 50/2057; G06Q 10/10

(57) ABSTRACT

Provided are a method and a system for generating a career plan for achieving a career goal. The method may commence with receiving user parameters and the career goal including a career title and a term for achieving the career goal by a user. The method may include identifying persons having the career title and establishing career patterns based on parameters of the persons. Each of the career patterns may include actions taken by the persons that resulted in achieving the career title by the persons. The method may include matching the user parameters with the actions and determining actions to be performed by the user to achieve the career goal and a timeline for performing the actions. The method may continue with comparing the timeline to the term for achieving the career goal and creating the career plan that may include the actions to be performed by the user.

### TECHNICAL FIELD

This invention relates generally to data processing and more particularly to generating a career plan for achieving a career goal.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

Students, recent graduates, and persons at any level of their professional growth may face difficulties in determining actions needed to achieve the next steps in their career. Even though people may understand general principles for building a career in their field of activity, they may have problems in determining whether their current skills and knowledge are sufficient for making a next step in their career plan. Furthermore, people may be in doubt as to what actions need to be done and how to increase chances of achieving their career goals.

Additionally, some people may want to make a transition from one field of activity to another. However, they may lack knowledge as to how their education, skills, and professional background can be useful at a position of interest in another field of activity and which skills and knowledge should be additionally acquired to achieve their career goal in another field of activity.

Furthermore, people may have a plurality of connections in social and professional networks. A person may want to follow a career path of a professional to whom the person is connected in a professional network. However, even though the person may see the profile and professional growth of this professional, specific actions to be performed by the person to follow the same or similar career path may be unclear.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to approaches for generating a career plan for achieving a career goal. According to one approach of the present disclosure, a system for generating a career plan for achieving a career goal is provided. Specifically, the system may include a data collection node, an analyzing node, and a storage node. The data collection node may be configured to receive, from a user, the career goal. The career goal may include at least a career title and a term for achieving the career goal. The data collection node may be further configured to receive user parameters associated with the user. The data collection node may be configured to identify a plurality of persons having the career title within a data network. Each of the plurality of persons may be associated with a set of parameters. The analyzing node may be configured to establish a plurality of career patterns based on the set of parameters. Each of the plurality of career patterns may be associated with one of the plurality of persons. Each of the career patterns may include a plurality of actions taken by the each of the plurality of persons that resulted in achieving the career title by the each of the plurality of persons. The analyzing node may be configured to match the user parameters with the plurality of actions associated with the plurality of career patterns and determine actions to be performed by the user to achieve the career goal and a timeline for performing the actions. The analyzing node may be further configured to compare the timeline for performing the actions to the term for achieving the career goal and, based on the comparison, create the career plan. The career plan may include the actions to be performed by the user. The storage node may be configured to store at least the user parameters, the plurality of career patterns, and the career plan.

According to another approach of the present disclosure, a method for generating a career plan for achieving a career goal is provided. The method may commence with receiving, by a data collection node, from a user, the career goal. The career goal may include at least a career title and a term for achieving the career goal. The method may continue with receiving, by the data collection node, user parameters associated with the user. The method may further include identifying, by the data collection node, a plurality of persons having the career title within a data network. Each of the plurality of persons may be associated with a set of parameters. The method may continue with establishing, by an analyzing node, a plurality of career patterns based on the set of parameters. Each of the plurality of career patterns may be associated with one of the plurality of persons. Each of the career patterns may include a plurality of actions taken by the each of the plurality of persons that resulted in achieving the career title by the each of the plurality of persons. The method may further include matching, by the analyzing node, the user parameters with the plurality of actions associated with the plurality of career patterns and determining actions to be performed by the user to achieve the career goal and a timeline for performing the actions. The method may continue with comparing, by the analyzing node, the timeline for performing the actions to the term for achieving the career goal and creating the career plan based on the comparison. The career plan may include the actions to be performed by the user.

In further example embodiments of the present disclosure, the method operations are stored on a machine-readable medium comprising instructions, which, when implemented by one or more processors, perform the recited operations. In yet further example embodiments, hardware systems or devices can be adapted to perform the recited operations. Other features, examples, and embodiments are described below.

### BRIEF DESCRIPTION OF THE DRAWINGS

Embodiments are illustrated by way of example, and not by limitation, in the figures of the accompanying drawings, in which like references indicate similar elements.

FIG. 1 shows an environment, within which methods and systems for generating a career plan for achieving a career goal can be implemented.

FIG. 2 shows a process flow diagram of a method for generating a career plan for achieving a career goal.

FIG. 3 shows a block diagram illustrating various modules of a system for generating a career plan for achieving a career goal.

FIG. 4 is a block diagram illustrating analyzing a career goal of a user by a system for generating a career plan for achieving a career goal.

FIG. 5 a block diagram showing a career plan generated by a system for generating a career plan for achieving a career goal.

FIG. 6 is a block diagram showing generation of a career plan by a system for generating a career plan for achieving a career goal.

FIG. 7 is a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits, programmable logic devices, or various combinations thereof. In particular, the methods described herein may be implemented by a series of computer-executable instructions residing on a storage medium, such as a disk drive or computer-readable medium. It should be noted that methods disclosed herein can be implemented by a computer (e.g., a desktop computer, a tablet computer, a laptop computer), a game console, a handheld gaming device, a cellular phone, a smart phone, a smart television system, and so forth.

As outlined in the summary, the embodiments of the present disclosure are directed to generating a career plan for achieving a career goal. A system for generating a career plan for achieving a career goal may be used as a career gap identifier to identify career gaps of a user and determine steps to be performed by the user to achieve the career goal. The system may be used to connect the user with members of a social or professional network to help the user to achieve the career goal based on data available for the members of the social or professional network.

More specifically, the user may provide his personal information, such as a current job position, education, work experience, skills, and the like to the system. In an example embodiment, the user may create a personal profile on a web platform associated with the system and store the personal information to the personal profile. The user may enter a career goal, namely a career title the user wants to achieve and a period of time within which the user wants to achieve the career title. In another example embodiment, the user may be connected to a plurality of members in the social or professional network and may select a person among the members the career of which the user wants to follow. Upon receiving the personal information and the career goal, the system may perform a search among all members of the social or professional network to identify persons having the same career title. The system may use parameters associated with the selected persons having the same career title to establish a plurality of career patterns. The career patterns may include career information for each of the selected persons identified based on personal data of the selected persons. More specifically, the career patterns may include education, skills, previous jobs' positions, connections in the social or professional network, a period of time the person held each of the previous jobs' positions, and the like.

The system may match the user parameters with the career patterns to identify career gaps of the user. The career gaps may be identified based on distinctions between the user parameters and the career information of the selected persons. The career gaps may include lack of specific skills, educational degrees, intermediate job positions, and the like. Based on the career gaps, the system may identify actions required to be performed by the user to achieve the career goal. Such actions may include acquiring skills, acquiring educational degrees, enrolling in an educational course, holding a job position, and the like. The system may use the required actions to generate a career plan for the user. The career plan may include all of the actions required to be performed by the user and a timeline for each action.

The system may determine that the career goal of the user cannot be achieved within the period of time set by the user. In this embodiment, the system may determine the amount of time needed to obtain the career title and may generate an alternative career plan based on the determined amount of time. In another example embodiment, the system may determine a career title which may be obtained by the user within the period of time set by the user. In this embodiment, the system may generate another alternative career plan based on the determined career title.

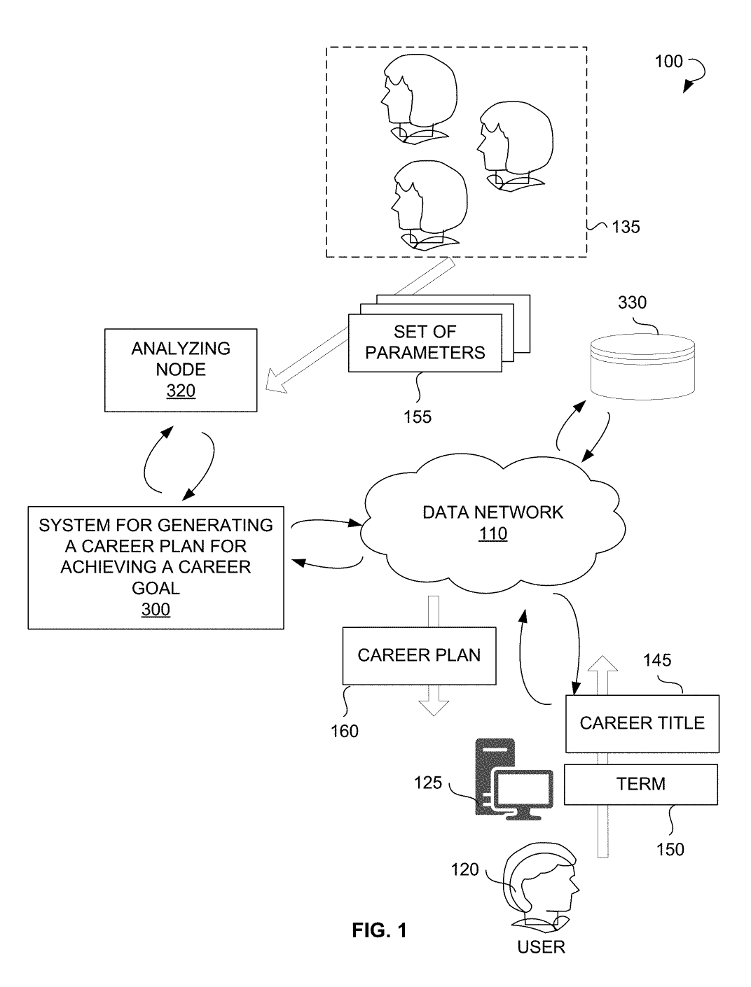

Referring now to the drawings, FIG. 1 illustrates an environment 100 within which methods and systems for generating a career plan for achieving a career goal can be implemented. The environment 100 may include a data network 110, a user 120, a user device 125, a system 300 for generating a career plan for achieving a career goal (also referred to as a system 300), a plurality of persons 135 connected to the data network 110, and a storage node 330. The user 120 may include users of network services (not shown) or network resources (not shown) within the data network 110, such as social networks, professional networks, web sites, web portals, and the like. The system 300 also may be connected to the network services and the network resources via the data network 110. The user device 125 may include a personal computer (PC), a laptop, a smartphone, a mobile phone, a tablet PC, a television set, an Internet phone, a netbook, so forth. The user 120 may provide a career title 145 and a term 150 for achieving the career title 145. The system 300 may receive the career title 145 and the term 150, as well as sets of parameters 155 associated with the persons 135. An analyzing node 320 of the system 300 may use the career title 145, the term 150, and the sets of parameters 155 for generating a career plan 160. The career plan 160 may be provided to the user device 125 and displayed to the user 120. The career title 145, the term 150, the sets of parameters 155, and the career plan 160 may be stored to the storage node 330.

The data network 110 may include a computing cloud, as well as the Internet or any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of an RS-232 serial connection, an IEEE-1394 (FireWire) connection, a Fiber Channel connection, an IrDA (infrared) port, a Small Computer Systems Interface connection, a Universal Serial Bus connection or other wired or wireless, digital or analog interface or connection, mesh or Digi® networking. The data network 110 may include a network of data processing nodes, also referred to as network nodes, that are interconnected for the purpose of data communication.

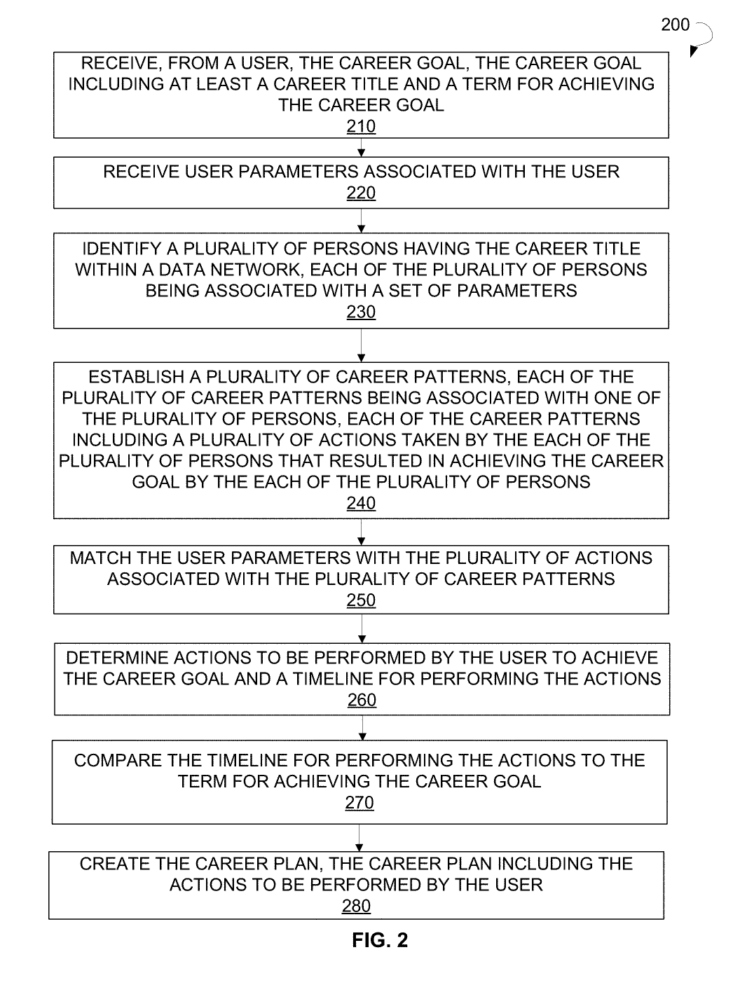

FIG. 2 shows a process flow diagram of a method 200 for generating a career plan for achieving a career goal, according to an example embodiment. In some embodiments, the operations may be combined, performed in parallel, or performed in a different order. The method 200 may also include additional or fewer operations than those illustrated. The method 200 may be performed by processing logic that may comprise hardware (e.g., decision making logic, dedicated logic, programmable logic, and microcode), software (such as software run on a general-purpose computer system or a dedicated machine), or a combination of both.

The method 200 may commence with receiving, by a data collection node, a career goal from a user at operation 210. The career goal may include at least a career title and a term for achieving the career goal. In an example embodiment, the user may be registered in a web platform associated with generating a career plan. The user may enter the career title and the term for achieving the career goal using a user device via a user interface associated with the web platform.

In some example embodiments, instead of entering the career title and the term for achieving the career goal, the user may select a person within a data network that has a career title or a career path similar to those the user wants to have. In this embodiment, the career title of the selected person may be considered to be the career title of the career goal of the user. The term within which the person achieved the career title may be considered to be the term for achieving the career goal of the user.

The method 200 may continue with receiving, by the data collection node, user parameters associated with the user at operation 220. The user parameters may include one or more of the following: a current job position, an education, an age, a geographic location, demographic data associated with the geographic location, a completed education course, a previous job position, a skill, and so forth. The user may provide the user parameters during registration in the web platform, during filling-in a user profile associated with the web platform, and so forth. In example embodiments, the user parameters may be received using third-party web sites or web services, such as social networks, professional networks, databases, and so forth.

The method 200 may further include identifying, by the data collection node, a plurality of persons having the career title within a data network at operation 230. The plurality of persons may include persons that have the career title at a current moment of time and persons that had the career title in the past. In an example embodiment, the plurality of persons may include users registered in the web platform, members of social networks, members of third-party web sites or web services, and so forth. Each of the plurality of persons may be associated with a set of parameters. A set of parameters associated with each of the plurality of persons may include personal parameters associated with the persons, such as a current job position, an education, a school from which each of the plurality of persons graduated, a university from which each of the plurality of persons graduated, an age, a place of birth, a geographic location, a completed education course, a previous job position, a term of occupying each of previous job positions, an age at which each of the plurality of persons occupied each of previous job positions, a skill, a professional certification, and so forth. The set of parameters may be obtained from personal profiles of the persons, from databases associated with third-party web sites or web services, from social networks, and any other available resources.

The method 200 may continue with establishing, by an analyzing node, a plurality of career patterns based on the set of parameters at operation 240. Each of the plurality of career patterns may be associated with one of the plurality of persons. More specifically, each of the career patterns may include a plurality of actions taken by the each of the plurality of persons that resulted in achieving the career title by the each of the plurality of persons. The plurality of actions taken by the each of the plurality of persons may include one or more of the following: acquiring a skill, graduating from a school, acquiring an educational degree, enrolling in an educational course, holding a job position, and so forth.

More specifically, persons who have or had the career title similar or identical to the career title entered by the user may be selected. The sets of parameters of the selected persons may be established to be career patterns for achieving the career title. In other words, actions taken by the selected persons (e.g., acquiring an educational degree, occupying an intermediate job position) and resulting in obtaining the career title may be used for establishing the career patterns.

The method 200 may further include matching, by the analyzing node, the user parameters with the plurality of actions associated with the plurality of career patterns at operation 250. Based on the matching, parameters of the selected persons that are not peculiar to the user can be identified. The identified parameters may show actions needed to be performed by the user to obtain the career title. The identified parameters may include an education, educational courses, a geographical location, skills, and the like.

The method 200 may continue with operation 260, at which the analyzing node may determine actions to be performed by the user to achieve the career goal and a timeline for performing the actions. The analyzing node may determine the actions based on the matching and the identified parameters. In an example embodiment, the actions to be performed by the user may include one or more of the following: acquiring a skill, accepting a job position, acquiring an educational degree, enrolling in an educational course, establishing a connection with a person via a social network, acquiring career information, acquiring an industry forecast concerning the career title, and so forth. The timeline for performing the actions may be determined based on determining a timeline needed for the selected persons to perform the actions taken by the selected persons.

The method 200 may continue with comparing, by the analyzing node, the timeline for performing the actions to the term for achieving the career goal at operation 270. The comparison may be performed based on the actions and the timeline for performing the actions.

The method 200 may further include creating, by the analyzing node, the career plan based on the comparison at operation 280. The career plan may include the actions to be performed by the user. In an example embodiment, the career plan may include a list of job positions to be taken by the user, skills needed for each of the job positions, a timeline for studying the required information and acquiring skills for each job position, and so forth.

In an example embodiment, the method 200 may further include determining that the timeline for performing the actions is different from the term for achieving the career goal. Based on such determination, the user may be requested to set an alternate term for achieving the career goal. The alternate term for achieving the career goal may correspond to the timeline for performing the actions. In an example embodiment, the timeline for performing the actions may be greater than the term for achieving the career goal set by the user. Therefore, the user may be requested to set an alternate term, which is greater than the term for achieving the career goal.

In a further example embodiment, the method 200 may include determining that the timeline for performing the actions is different from the term for achieving the career goal. Based on such determination, an alternate career title to be achieved within the term for achieving the career goal may be established. The user may be requested to replace the career title in the career goal with the alternate career title. The alternate career title may be determined based on job positions obtained by the persons within the term for achieving the career goal.

In an example embodiment, the method 200 may include generating a career map associated with the career plan. The career map may include indicia of the actions to be performed by the user. The career map may be displayed to the user.

The method 200 may further include accessing a recruiting database that comprises a plurality of open job positions and selecting an open job position associated with the actions to be performed by the user according to the career plan. Data associated with the open job position may be provided to the user.

The method 200 may further include accessing a career path community that may include a plurality of members having career goals similar to the career goal of the user. The user may be a member of the career path community. The members of the career path community can help each other to develop and achieve career goals.

The method 200 may further include accessing an educational platform that may comprise a plurality of educational courses and selecting an educational course associated with the actions to be performed by the user according to the career plan. Data associated with the educational course may be provided to the user.

The method 200 may further include monitoring one or more actions performed by the user according to the career plan. Based on the one or more actions, an additional action for the career plan may be created. The user may be prompted to perform the additional action. The method 200 may further include monitoring a timeline for performing the one or more actions by the user according to the career plan. The timeline for performing the one or more actions may be compared with the timeline for performing the actions determined based on the matching. Therefore, it may be determined whether the one or more actions performed by the user are performed in accordance with the timeline for performing the actions. In case the user does not follow the timeline for performing the actions, reminders may be provided to the user. The reminders may include notifications showing next actions to be performed by the user.

In some example embodiments, the method 200 may include determining that the user does not perform the actions according to the timeline for performing the actions. In this case, it may be determined that the career goal cannot be achieved within the time remaining until the term for achieving the career goal ends, and an alternative career plan may be generated for the user. The alternative career plan may include an alternate term for achieving the career goal that is longer than the term for achieving the career goal set by the user. In other cases, the alternative career plan may include an alternate career title that may be a career title located lower in a career ladder than the career title set by the user in the career goal.

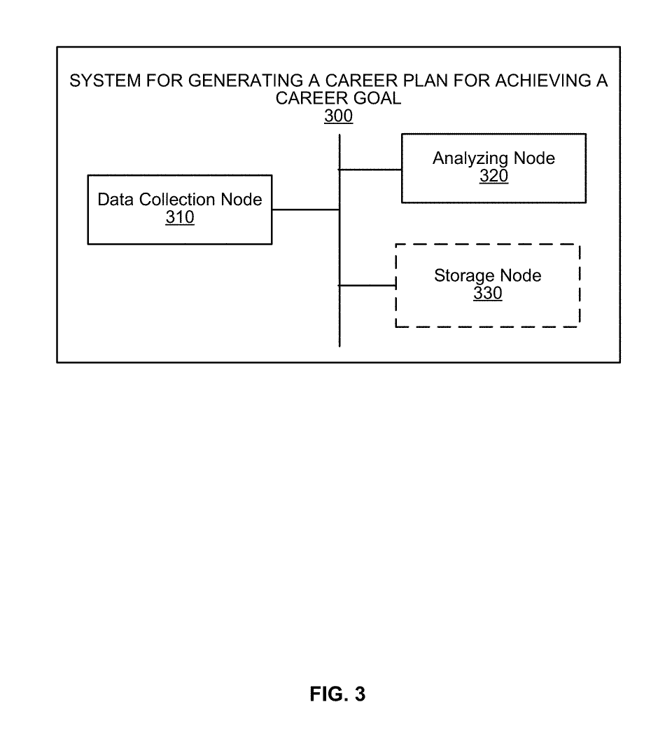

FIG. 3 shows a block diagram illustrating various modules of a system 300 for generating a career plan for achieving a career goal, according to an example embodiment. Specifically, the system 300 may include a data collection node 310, an analyzing node 320, and optionally a storage node 330.

The data collection node 310 may be configured to receive, from a user, the career goal. The career goal may include at least a career title and a term for achieving the career goal. The data collection node 310 may be further configured to receive user parameters associated with the user. In an example embodiment, the user parameters may include one or more of the following: a current job position, an education, schools and universities from which the user graduated, an age, a place of birth, a geographic location, a completed education course, a previous job position, a skill, professional background, professional certifications, curriculum vitae information, and so forth.

The data collection node 310 may identify a plurality of persons having the career title within a data network. Each of the plurality of persons may be associated with a set of parameters. The analyzing node 320 may be configured to establish a plurality of career patterns based on the set of parameters. Each of the plurality of career patterns may be associated with one of the plurality of persons. Each of the career patterns may include a plurality of actions taken by the each of the plurality of persons that resulted in achieving the career title by the each of the plurality of persons. The plurality of actions taken by the each of the plurality of persons may include one or more of the following: acquiring a skill, graduating from a school, graduating from a university, acquiring an educational degree, enrolling in an educational course, holding a job position, obtaining a specific amount of salary, moving to a geographical location, and so forth.

The analyzing node 320 may be further configured to match the user parameters with the plurality of actions associated with the plurality of career patterns. The analyzing node 320 may further determine actions to be performed by the user to achieve the career goal and a timeline for performing the actions. The actions and the timeline for performing the actions may be determined based on the matching. In an example embodiment, the actions to be performed by the user may include one or more of the following: acquiring a skill, accepting a job position, acquiring an educational degree, enrolling in an educational course, establishing a connection via a social network, acquiring career information, acquiring an industry forecast concerning the career title, obtaining a specific rate of wage, moving to a geographical location, and so forth.

Based on the actions and the timeline for performing the actions, the analyzing node 320 may compare the timeline for performing the actions to the term for achieving the career goal. Based on the comparison, the analyzing node 320 may create the career plan. The career plan may include the actions to be performed by the user.

In an example embodiment, the analyzing node 320 may be further configured to determine that the timeline for performing the actions is different from the term for achieving the career goal. Based on the determining that the timeline for performing the actions is different from the term for achieving the career goal, the analyzing node may request the user to set an alternate term for achieving the career goal. The alternate term for achieving the career goal may correspond to the timeline for performing the actions.

The analyzing node 320 may be further configured to determine that the timeline for performing the actions is different from the term for achieving the career goal. Based on such determination, the analyzing node 320 may establish an alternate career title to be achieved within the term for achieving the career goal. The analyzing node 320 may request the user to replace the career title in the career goal with the alternate career title.

In an example embodiment, the analyzing node 320 may be configured to generate a career map associated with the career plan. The career map may include indicia of the actions to be performed by the user. The career map may be displayed to the user via a user device.

The analyzing node 320 may be further configured to access a recruiting database that comprises a plurality of open job positions. The analyzing node 320 may select, from the plurality of open job positions, an open job position associated the actions to be performed by the user according to the career plan. Data associated with the open job position may be provided to the user.

The analyzing node 320 may be further configured to access an educational platform that comprises a plurality of educational courses. The educational courses may include online courses, offline courses, educational materials, e-learning programs, professional conferences, webinars, publications related to the field associated with the career goal, and so forth. The analyzing node 320 may select, from the plurality of educational courses, an educational course associated with the actions to be performed by the user according to the career plan. Data associated with the educational course may be provided to the user.

The analyzing node 320 may be further configured to monitor one or more actions performed by the user according to the career plan. Based on the monitoring, the analyzing node 320 may create an additional action for the career plan and prompt the user to perform the additional action.

The analyzing node 320 may be further configured to monitor a timeline for performing the one or more actions by the user. The analyzing node 320 may compare the timeline for performing the one or more actions with the timeline for performing the actions determined based on the matching.

In an example embodiment, the analyzing node 320 may include a processor or an artificial intelligence engine. Alternatively, the data collection node 310 and the analyzing node 320 may be combined into the artificial intelligence engine. The artificial intelligence engine may be used to manage information, such as user parameters and sets of parameters of the persons, and take actions based on predetermined criteria. When managing the information, the artificial intelligence engine may utilize statistical methods, computational intelligence, machine learning, mathematical optimization, logic methods, probability-based methods, and so forth. The artificial intelligence engine may analyze whether career plans generated by the artificial intelligence engine were used or approved by users, whether users managed to follow the generated career plans, whether adjustments of career plans were needed when users performed actions according to the career plans, and the like. Based on machine learning, all actions taken by the users according to the career plans, progress of the users in following the career plans, timelines, and adjustments of career plans by the users or by the artificial intelligence engine may be analyzed to optimize generation of career plans for further users. Additionally, the artificial intelligence engine may generate a plurality of career plans for the user and score the career plans based on predetermined criteria or based on machine learning algorithms. Based on the scoring, the artificial intelligence engine may rank the career plans and select a career plan that is the most suitable career plan for the user in view of previously generated career plans for other users and in view of analyzed progress of the users according to their career plans.

The storage node 330 may be configured to store at least the user parameters, the plurality of career patterns, and the career plan. The career patterns may be stored to the storage node 330 as existing career paths, which may be used for generating career plans for further users.

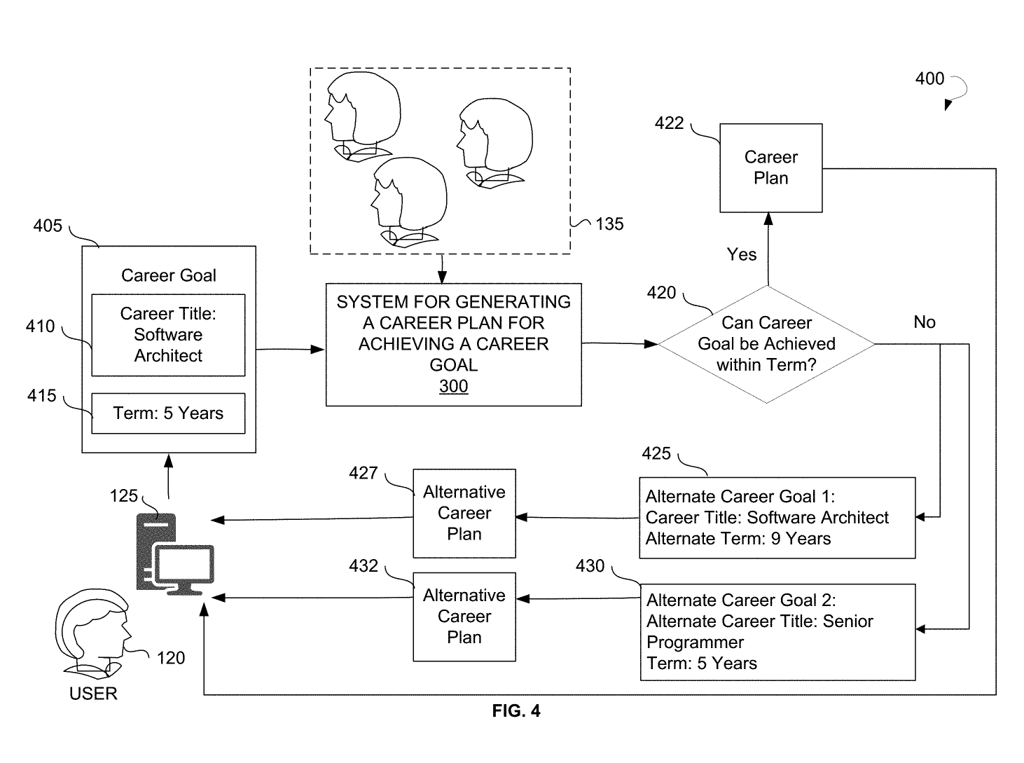

FIG. 4 is a block diagram 400 illustrating processing a career goal of a user by the system 300 for generating a career plan for achieving a career goal, according to an example embodiment. The user 120 may enter a career goal 405 using a user device 125. More specifically, the career goal 405 entered by the user 120 may include a career title 410 and a term 415 for achieving the career goal 405. For example, the career title 410 entered by the user 120 may include ‘Software Architect’. In other example embodiments, the career title 410 entered by the user 120 may include any other career title. The term 415 entered by the user 120 may include five years. In other example embodiments, the term 415 may include any other period of time.

The system 300 may receive the career goal 405 entered by the user 120. The system 300 may be connected to a data network (not shown) and may access sets of parameters associated with a plurality of persons 135 connected to the data network. In an example embodiment, the persons 135 may include members of a professional network associated with the user 120. The sets of parameters may include personal information of the persons 135, career paths of the persons 135, previous job positions, current job positions, education degrees acquired by the persons 135, educational courses attained by the persons 135, and other career-relevant information.

The system 300 may analyze the career title 410 and the term 415 based on the sets of parameters of the persons 135 to generate a career plan for the user 120. During the analysis, the system 300 may determine, at block 420, whether the career goal 405 set by the user 120 can be achieved within the term 415. If the system 300 determines, at block 420, that the career goal 405 can be achieved within the term 415, a career plan 422 can be generated based on the career goal 405 and the term 415. The system 300 can then provide the career plan 422 to the user device 125.

In another example embodiment, the system 300 may determine, at block 420, that the career goal 405 set by the user 120 cannot be achieved within the term 415. Such determination can be made by the system 300 when the analysis shows that the persons 135 did not achieve a career title being the same as or similar to the career title 410 within the term 415. Based on such determination, the system 300 may generate an alternate career goal 425. The alternate career goal 425 may include a career title being the same as the career title 410, such as a software architect, but may include an alternate term for achieving the career goal (for example, nine years). Furthermore, the system 300 can generate an alternative career plan 427 for the alternate career goal 425. The system 300 may provide the alternate career goal 425 and the alternative career plan 427 to the user device 125.

Additionally, the system 300 may generate an alternate career goal 430. The alternate career goal 430 may include a term for achieving the career goal being the same as the term 415, i.e., five years, and may include an alternate career title that may differ from the career title 410. The alternate career title may be the career title that is possible to be achieved within the term 415. The alternate career title may include, for example, a senior programmer. Furthermore, the system 300 can generate an alternative career plan 432 for the alternate career goal 430. The system 300 may provide the alternate career goal 430 and the alternative career plan 432 to the user device 125.

The user 120 may receive the alternate career goal 425 and the alternate career goal 430, review the alternative career plan 427 and the alternative career plan 432, and change the career goal 405. The user 120 may change the career goal 405 either by changing the career title 410 according to the alternate career title suggested in the alternate career goal 430, or by changing the term 415 according to the alternate term suggested in the alternate career goal 425.

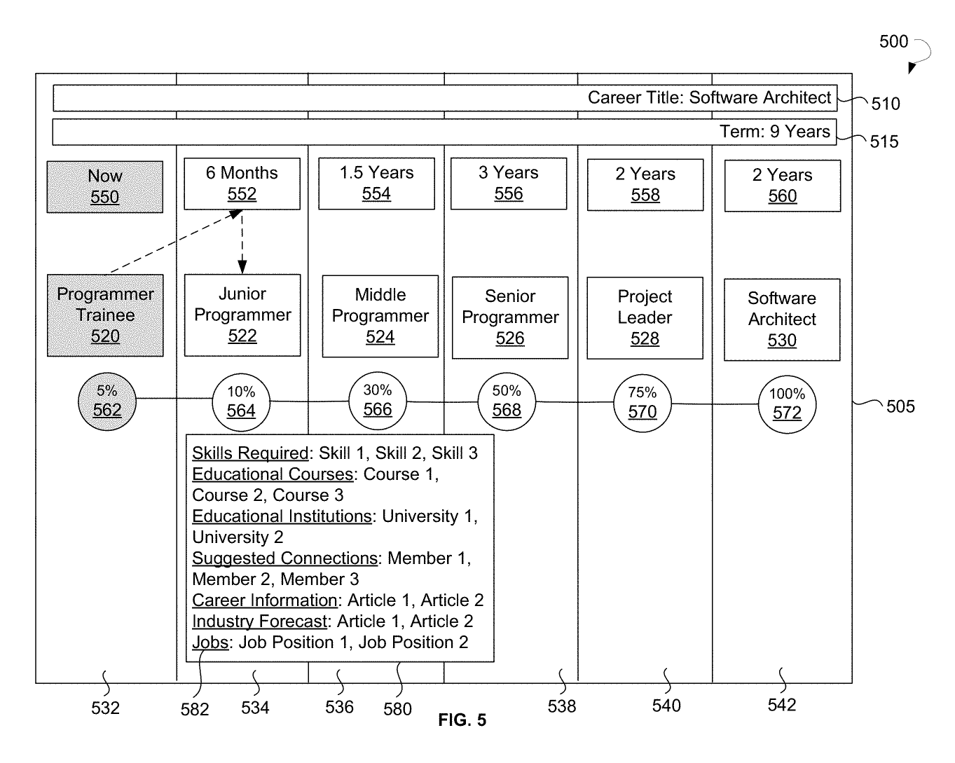

FIG. 5 is a block diagram 500 showing a career plan 505 generated by a system for generating a career plan for achieving a career goal, according to an example embodiment. The career plan 505 may be a career map and may be generated based on a career title 510 and a term 515 for achieving a career goal entered by a user. The career plan 505 may include a current career title 520 of the user, such as ‘Programmer Trainee’. The career plan 505 may be divided into periods 532, 534, 536, 538, 540, and 542. Each of the periods 532, 534, 536, 538, 540, and 542 may be associated with intermediate career goals of the career plan 505. The intermediate career goals may include obtaining intermediate career positions shown as career titles 522, 524, 526, 528, and 530. Each of the periods 532, 534, 536, 538, 540, and 542 may have a timeline shown as timeline 550, 552, 554, 556, 558, and 560.

In an example embodiment, the user occupies a position shown by the current career title 520. The timeline 550 may be shown as ‘Now’ to show that the user occupies the position of ‘Programmer Trainee’ shown by the current career title 520 at a current moment of time. Therefore, the period 532 may correspond to the current moment of time. The timeline 550 and the current career title 520 of the current moment of time, i.e., of the period 532, may be visually indicated. In an example embodiment, the visual indication may include highlighting, using specific fonts styles and colors, and the like.

According to the career plan 505, the next career title to be obtained by the user is ‘Junior Programmer’ shown by the career title 522. The career title 522 is associated with the period 534. The timeline 552 may represent a period of time needed for the user to obtain the career title 522. For example, it may take six months, as shown by the timeline 552, for the user to acquire skills needed for obtaining the career title 522.

Each of the career titles 522, 524, 526, 528, and 530 may be associated with a percentage value 562, 564, 566, 568, 570, and 572. The percentage values 562, 564, 566, 568, 570, and 572 may show a percentage of the career goal achieved by the user. For example, occupying the position of ‘Programmer Trainee’ shown by the current career title 520 may correspond to achieving 5% of the career goal, as shown by the percentage value 562. Occupation of the position of ‘Software Architect’ shown by the career title 530 may correspond to achieving 100% of the career goal, as shown by the percentage value 572. The percentage values 562, 564, 566, 568, 570, and 572 may serve as a career mood index identifying the level of achievement of the career goal by the user.

During each of the periods 532, 534, 536, 538, 540, and 542, the career plan 505 may provide the user with information as to how to obtain the next career title. For example, the user having the current career title 520 may select the next career title, such as the career title 522. Upon selection of the career title 522, a menu 580 may be opened. The menu 580 may represent actions to be performed by the user to achieve the next career title, such as the career title 522 shown as ‘Junior Programmer’. The actions to be performed by the user may include a list of skills to be acquired by the user, educational courses to be enrolled in by the user, educational institutions where the user may acquire an educational degree, suggested connections to be established by the user in the professional network, career information to be acquired or studied by the user, industry forecasts to be acquired by the user, and job positions to be obtained. The suggested connections may include people who can potentially help the user to achieve the career goals, such as coaches, professors, people having similar career paths or similar career titles, and so forth. Additionally, the menu 580 may represent salary information associated with the next career title, i.e., an approximate amount of salary the user may receive upon obtaining the career title 522.

In an example embodiment, when the user selects a ‘Jobs’ link 582 of the menu 580, a recruiting database may be opened. Open positions associated with the next career title, such as the career title 522, may be displayed to the user. For example, open job positions for the ‘Junior Programmer’ may be shown to the user. The user may apply for the open positions. Additionally, the user may send a curriculum vitae of the user to the recruiting database so that employers may consider the user as a candidate for obtaining the open position.

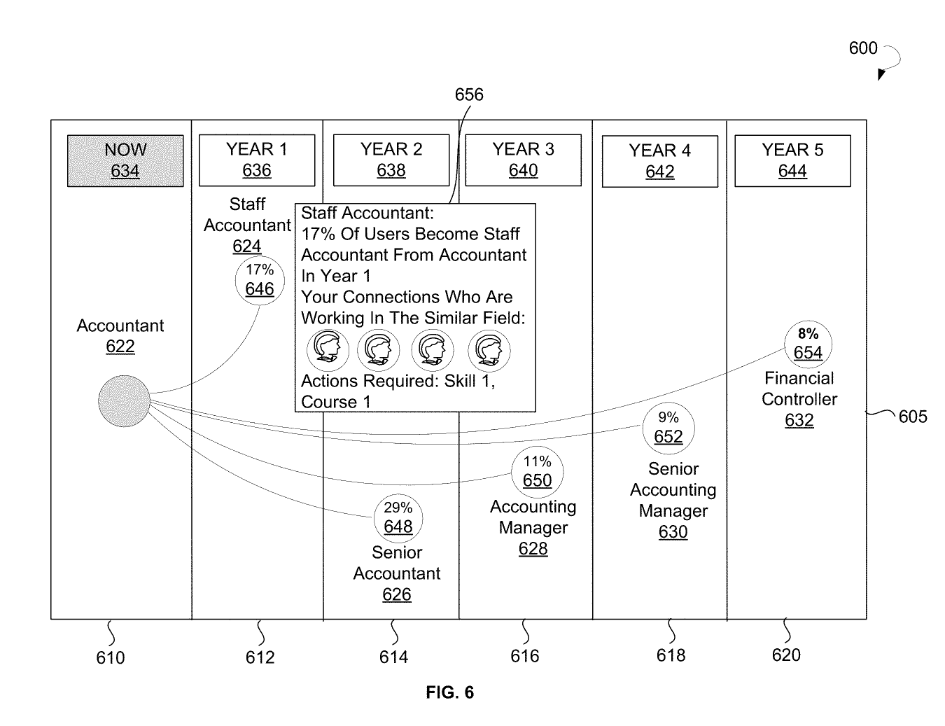

FIG. 6 is a block diagram 600 showing generating a career plan 605 by a system for generating a career plan for achieving a career goal, according to an example embodiment. The career plan 605 may be divided into periods 610, 612, 614, 616, 618, and 620. Each of the periods 610, 612, 614, 616, 618, and 620 may be associated with one of job positions 622, 624, 626, 628, 630, and 632 to be obtained by the user according to the career plan 605. Furthermore, each of the periods 610, 612, 614, 616, 618, and 620 may be associated with a timeline 634, 636, 638, 640, 642, and 644 for obtaining each of the job positions 622, 624, 626, 628, 630, and 632. The career plan 605 may be generated for the career title ‘Financial Controller’ shown as the job position 632 and for the term of five years shown by the timeline 644.

In an example embodiment, the user may have a current job position of ‘Accountant’ shown as the job position 622. According to the career plan 605, next job positions for the user may include: ‘Staff Accountant’ shown as the job position 624, which is required to be obtained by the user within one year as shown by the timeline 636, ‘Senior Accountant’ shown as the job position 626, which is required to be obtained by the user within two years as shown by the timeline 638, ‘Accounting Manager’ shown as the job position 628, which is required to be obtained by the user within three years as shown by the timeline 640, ‘Senior Accounting Manager’ shown as the job position 630, which is required to be obtained by the user within four years as shown by the timeline 642, and ‘Financial Controller’ shown as the job position 632, which is required to be obtained by the user within five years as shown by the timeline 644.

The career plan 605 may be generated based on information associated with members of the social network. In some embodiments, the members of the financial network may be connected to the user and may be involved in a field similar to the field associated with the career goal of the user. The career plan 605 may display statistical information, such as indexes 646, 648, 650, 652, and 654. The indexes 646, 648, 650, 652, and 654 may represent the percentage of members of the financial network that obtained the job positions 622, 624, 626, 628, 630, and 632 within the timeline 634, 636, 638, 640, 642, and 644, respectively. For example, the index 646 showing the percentage of 17% may show that 17% of the members of the financial network changed the position of ‘Accountant’ shown as the job position 622 to the job position of ‘Staff Accountant’ shown as the job position 624 within one year shown by the timeline 634. Similarly, the index 654 showing the percentage of 8% may show that 8% of the members of the financial network changed the position of ‘Accountant’ shown as the job position 622 to the job position of ‘Financial Controller’ shown as the job position 632 within five years shown by the timeline 644.

The user having the a current job position of ‘Accountant’ shown as the job position 622 may select the next job position in the career plan 605 shown as the job position 624. Upon selection of the job position 624, a menu 656 may be displayed to the user. The menu 656 may include statistical information showing the percentage of members of the financial network that obtained the job position 624, members that are working in a similar technical field, and other relevant information. The menu 656 may further include information in respect to actions required to be performed by the user to obtain the job position 624, such as acquiring a skill, enrolling in a course, acquiring an educational degree, college degree, and so forth.

In an example embodiment, the user may enter the current job position of ‘Accountant’ shown as the job position 622. Based on the user parameters and the job position 622, a career title and a term for achieving the career title may be selected for the user and the career plan 605 may be generated as one of possible career paths that can be achieved by the user. The job positions 622, 624, 626, 628, 630, and 632 and the timelines 634, 636, 638, 640, 642, and 644 may be determined based on analysis of parameters of the persons having the job position of ‘Accountant’ in their career paths.

In an example embodiment, based on the user parameters and the job position 622, several alternative career plans may be generated for the user. The user may review the generated alternative career plans, evaluate efforts needed for each of the alternative career plans, and select one of the alternative career plans according to preferences of the user.

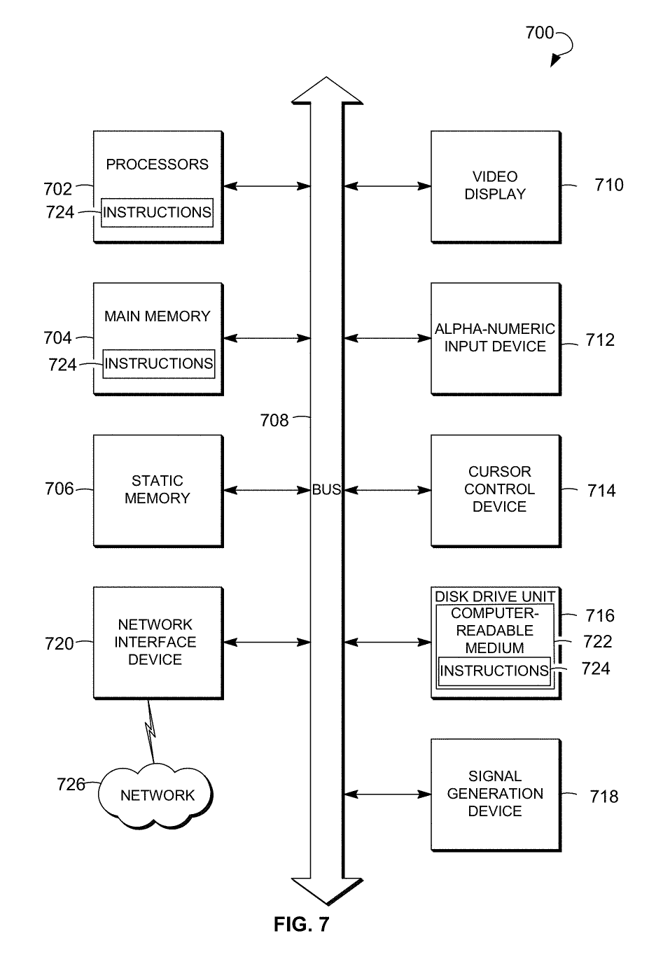

FIG. 7 shows a diagrammatic representation of a machine in the example electronic form of a computer system 700, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box, a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

According to an example embodiment, the computer system 700 includes a processor or multiple processors 702 (e.g., a central processing unit, a graphics processing unit, or both), a main memory 704 and a static memory 706, which communicate with each other via a bus 708. The computer system 700 may further include a video display unit 710 (e.g., a liquid crystal display or a cathode ray tube). The computer system 700 may also include an alphanumeric input device 712 (e.g., a keyboard), a cursor control device 714 (e.g., a mouse), a disk drive unit 716, a signal generation device 718 (e.g., a speaker), and a network interface device 720.

The disk drive unit 716 includes a non-transitory computer-readable medium 722, on which is stored one or more sets of instructions and data structures (e.g., instructions 724) embodying or utilized by any one or more of the methodologies or functions described herein. The instructions 724 may also reside, completely or at least partially, within the main memory 704 and/or within the processors 702 during execution thereof by the computer system 700. The main memory 704 and the processors 702 may also constitute machine-readable media.

The instructions 724 may further be transmitted or received over a network 726 via the network interface device 720 utilizing any one of a number of well-known transfer protocols (e.g., Hyper Text Transfer Protocol).

While the non-transitory computer-readable medium 722 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory, read only memory, and the like.

The example embodiments described herein may be implemented in an operating environment comprising software installed on a computer, in hardware, or in a combination of software and hardware.

Thus, methods and systems for generating a career plan for achieving a career goal have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A system for generating a career plan for achieving a career goal, the system comprising:
a data collection node configured to:
receive, from a user, the career goal, the career goal including at least a career title and a term for achieving the career goal;
receive user parameters associated with the user; and
identify a plurality of persons having the career title within a data network, each of the plurality of persons being associated with a set of parameters;
an analyzing node configured to:
based on the set of parameters, establish a plurality of career patterns, each of the plurality of career patterns being associated with one of the plurality of persons, each of the career patterns including a plurality of actions taken by the each of the plurality of persons that resulted in achieving the career title by the each of the plurality of persons;
match the user parameters with the plurality of actions associated with the plurality of career patterns;
based on the matching, determine actions to be performed by the user to achieve the career goal and a timeline for performing the actions;
based on the actions and the timeline for performing the actions, comparing the timeline for performing the actions to the term for achieving the career goal; and
based on the comparison, create the career plan, the career plan including the actions to be performed by the user; and
a storage node configured to store at least the user parameters, the plurality of career patterns, and the career plan.

2. The system of claim 1, wherein the actions to be performed by the user include one or more of the following: acquiring a skill, accepting a job position, acquiring an educational degree, enrolling in an educational course, establishing a connection via a social network, acquiring career information, and acquiring an industry forecast concerning the career title.

3. The system of claim 1, wherein the analyzing node is further configured to:
determine that the timeline for performing the actions is different from the term for achieving the career goal; and
based on the determining that the timeline for performing the actions is different from the term for achieving the career goal, request the user to set an alternate term for achieving the career goal, the alternate term for achieving the career goal corresponding to the timeline for performing the actions.

4. The system of claim 1, wherein the analyzing node is further configured to:
determine that the timeline for performing the actions is different from the term for achieving the career goal;
based on the determination, establish an alternate career title to be achieved within the term for achieving the career goal; and
request the user to replace the career title in the career goal with the alternate career title.

5. The system of claim 1, wherein the plurality of actions taken by the each of the plurality of persons includes one or more of the following: acquiring a skill, graduating from a school, acquiring an educational degree, enrolling in an educational course, and holding a job position.

6. The system of claim 1, wherein the analyzing node is further configured to:
generate a career map associated with the career plan, the career map including indicia of the actions to be performed by the user; and
display the career map to the user.

7. The system of claim 1, wherein the analyzing node is further configured to:
access a recruiting database, the recruiting database comprising a plurality of open job positions;
select, from the plurality of open job positions, an open job position associated with the actions to be performed by the user according to the career plan; and
providing data associated with the open job position to the user.

8. The system of claim 1, wherein the analyzing node is further configured to:
access an educational platform, the educational platform comprising a plurality of educational courses;
select, from the plurality of educational courses, an educational course associated with the actions to be performed by the user according to the career plan; and
provide data associated with the educational course to the user.

9. The system of claim 1, wherein the user parameters include one or more of the following: a current job position, an education, an age, a geographic location, a completed education course, a previous job position, and a skill.

10. The system of claim 1, wherein the analyzing node is further configured to:
monitor one or more actions performed by the user according to the career plan;
based on the one or more actions, create an additional action for the career plan; and
prompt the user to perform the additional action.

11. The system of claim 10, further comprising:
monitor a timeline for performing the one or more actions by the user; and
compare the timeline for performing the one or more actions with the timeline for performing the actions determined based on the matching.

12. A method for generating a career plan for achieving a career goal, the method comprising:
receiving, by a data collection node, from a user, the career goal, the career goal including at least a career title and a term for achieving the career goal;
receiving, by the data collection node, user parameters associated with the user;
identifying, by the data collection node, a plurality of persons having the career title within a data network, each of the plurality of persons being associated with a set of parameters;
based on the set of parameters, establishing, by an analyzing node, a plurality of career patterns, each of the plurality of career patterns being associated with one of the plurality of persons, each of the career patterns including a plurality of actions taken by the each of the plurality of persons that resulted in achieving the career title by the each of the plurality of persons;
matching, by the analyzing node, the user parameters with the plurality of actions associated with the plurality of career patterns;
based on the matching, determining, by the analyzing node, actions to be performed by the user to achieve the career goal and a timeline for performing the actions;
based on the actions and the timeline for performing the actions, comparing, by the analyzing node, the timeline for performing the actions to the term for achieving the career goal; and
based on the comparison, creating, by the analyzing node, the career plan, the career plan including the actions to be performed by the user.

13. The method of claim 12, further comprising:
determining that the timeline for performing the actions is different from the term for achieving the career goal; and
based on the determining that the timeline for performing the actions is different from the term for achieving the career goal, requesting the user to set an alternate term for achieving the career goal, the alternate term for achieving the career goal corresponding to the timeline for performing the actions.

14. The method of claim 12, further comprising:
determining that the timeline for performing the actions is different from the term for achieving the career goal;
based on the determination, establishing an alternate career title to be achieved within the term for achieving the career goal; and
requesting the user to replace the career title in the career goal with the alternate career title.

15. The method of claim 12, further comprising:
generating a career map associated with the career plan, the career map including indicia of the actions to be performed by the user; and
displaying the career map to the user.

16. The method of claim 12, further comprising:
accessing a recruiting database, the recruiting database comprising a plurality of open job positions;
selecting, from the plurality of open job positions, an open job position associated with the actions to be performed by the user according to the career plan; and
providing data associated with the open job position to the user.

17. The method of claim 12, further comprising:
accessing an educational platform, the educational platform comprising a plurality of educational courses;
selecting, from the plurality of educational courses, an educational course associated with the actions to be performed by the user according to the career plan; and
providing data associated with the educational course to the user.

18. The method of claim 12, further comprising:
monitoring one or more actions performed by the user according to the career plan;
based on the one or more actions, creating an additional action for the career plan; and
prompting the user to perform the additional action.

19. The method of claim 18, further comprising:
monitoring a timeline for performing the one or more actions by the user; and
comparing the timeline for performing the one or more actions with the timeline for performing the actions determined based on the matching.

20. A system for generating a career plan for achieving a career goal, the system comprising:
a data collection node configured to:
receive, from a user, the career goal, the career goal including at least a career title and a term for achieving the career goal;
receive user parameters associated with the user; and
identify a plurality of persons having the career title within a data network, each of the plurality of persons being associated with a set of parameters;
an analyzing node configured to:
based on the set of parameters, establish a plurality of career patterns, each of the plurality of career patterns being associated with one of the plurality of persons, each of the career patterns including a plurality of actions taken by the each of the plurality of persons that resulted in achieving the career title by the each of the plurality of persons;
match the user parameters with the plurality of actions associated with the plurality of career patterns;
based on the matching, determine actions to be performed by the user to achieve the career goal and a timeline for performing the actions;
based on the actions and the timeline for performing the actions, compare the timeline for performing the actions to the term for achieving the career goal; and
based on the comparison, create the career plan, the career plan including the actions to be performed by the user;
generate a career map associated with the career plan, the career map including indicia of the actions to be performed by the user;
display the career map to the user;
access a recruiting database, the recruiting database comprising a plurality of open job positions;
select, from the plurality of open job positions, an open job position associated with the actions to be performed by the user according to the career plan; and
provide data associated with the open job position to the user; and
a storage node configured to store at least the user parameters, the plurality of career patterns, and the career plan.
